(19) United States
(12) Patent Application Publication
(10) Pub. No.: US 2005/0006240 A1
(43) Pub. Date: Jan. 13, 2005

(54) Field generating membrane electrode

(76) Inventors: Renate Bender, Darmstadt (DE); Thomas Greve, Darmstadt (DE); Karl-Heinz Derwenskus, Darmstadt (DE); Matthias Johnck, Dortmund (DE); Sigrid Sturmfels, Gross-Umstadt (DE); Bernd Stanislawski, Frankfurt (DE); Dusan Kaniansky, Bratislava (SK); Marian Masar, Podolie (SK); Robert Bodor, Velke Dravce (SK)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/496,951

(22) PCT Filed: Oct. 30, 2002
(86) PCT No.: PCT/EP02/12103

(30) Foreign Application Priority Data
Nov. 26, 2001 (EP) 01128031.0

(51) Int. Cl. G01N 27/403

(52) U.S. Cl. 204/600; 204/450

(57) ABSTRACT

The present invention provides a field generating membrane electrode for contact with an electrolyte solution comprising a wetable membrane which is ion permeable under electric field conditions and an electrically conductive material for connection with a source of electrical charges, characterized in that one side of the membrane is in direct contact with the electrolyte solution and the other side of the membrane is in direct contact with the electrically conductive material and a gas receiving volume. The electrode according to the present invention is especially useful for electrokinetic transport, electrokinetic pumping, electrophoretic transport, isotachophoretic transport, separation of ions or electrochemical reaction of ions.

The present invention relates to membrane covered polarized electrodes useful to generate a high voltage electric field within aqueous solutions of electrolytes while there is no development of gas bubbles due electrolysis within the electrolyte solution.

### BACKGROUND OF THE INVENTION

In a solution of ions an electrical field can be generated by polarized electrodes. The electrical field results in a voltage drop between the electrodes and forces the ions to move onto the electrode with the opposite charge. The electrokinetic transport of ions within the bulk solution is accompanied by charge transfer processes at the electrodes. Due to the electrode potential, charges are transferred between the electrolyte solution and the surface of the electrodes. Concomitantly, electrochemical reactions take place: The ions are neutralized and disposed on the surface, transported into the electrode or build up an additional chemical phase. This may result in the electrolytic decomposition of water, other solvents and solvated molecules.

In all these reactions gases are often generated which appear in the form of gas bubbles at the surface of solid electrodes.

An illustrative simple example is the electrophoretic transport of ions in aqueous solution of sodium chloride, NaCl:

The electrochemical potential of sodium cations is highly negative. Therefore the following electrochemical reaction takes places at the cathode:
2 H⁺+2 e⁻>>H_{2 (gas)}

At the anode depending on the pH value the following reactions occur:
4 OH⁻>>4 e⁻+O_{2(gas)}+2H₂O
or
2Cl⁻>>2e⁻+Cl_{2(gas)}

In many cases the presence of gas within the working solution, i.e. the electrolyte solution in which electrolytic transport e.g. for analysis or synthesis purposes shall be achieved, is not desirable. The bubbles disturb the electric field generated by the electrodes and tend to stick to the walls of the vessel in which the working solution is present. These problems are very important for the reproducibility of electrophoretic separations especially when the vessel is either a microfluidic system or any system of connected cavities like porous silica gel.

In a current practice of electrophoretic transport the electrodes are located in separate open vessels that are connected with the working solution by fluid bridges. The solutions in the bridges can be hydrodynamically separated by ion-permeable membranes from those in the open vessels.

The gas bubbles developing at the electrode surface are separated from the surrounding electrolyte solution due to their lower densities. The bubbles are disappearing to the atmosphere or are collected within a so-called gas trap.

When the solid electrode is immersed into an aqueous solution behind the membrane the formations of gas bubbles takes place without interfering the working solution. The flow of liquids is prevented and the electromigration of ions is permitted.

In practice there are several drawbacks of this design:

1. The extra compartments for the electrodes require extra maintenance and filling procedures. This is, especially, demanding for miniaturized analytical systems provided with miniaturized electrodes. Miniaturized electrodes are dedicated to delivery of an electric field to a fluid containment with typical wall to wall distances between 1 μm and 1 mm. Because the diameter of gas bubbles is within this range there is a high risk that the containment is clogged by the gas bubbles. Because of this problem electrodes with open reservoirs need to be used for miniaturized electrophoretic devices in such a way that the fluid flow within the device can be controlled efficiently.

2. The composition of the solution within the electrode compartment is changed during the electrolytic process. The electrochemical properties and the osmotic pressure have to be controlled.

In order of a simplified handling and especially for miniaturized electrophoretic set ups a solid electrode without formation of gas bubbles or eliminating the gas formed at the electrode outside the solution, without an additional solution compartment, would be of advantage.

### DESCRIPTION OF THE INVENTION

Surprisingly, it was found that it is possible to construct a field generating solid electrode which shows no bubble formation on the side of the working solution, i.e. the electrolyte solution, when an ion permeable membrane is placed in direct contact with an electrically conductive solid material preferably provided with a series of holes.

The present invention therefore relates to a field generating membrane electrode for contact with an electrolyte solution comprising a wetable membrane which is ion permeable under electric field conditions and an electrically conductive material for connection with a source of electrical charges, characterized in that one side of the membrane is in direct contact with the electrolyte solution and the other side of the membrane is in direct contact with the electrically conductive material and a gas receiving volume.

In a preferred embodiment of the field generating membrane electrode according to the present invention, the electrically conductive material is a metal foil, body or film or mesh of small filaments.

In another preferred embodiment the contact of the membrane with the gas receiving volume is achieved by at least one hole in the electrically conductive material.

In another preferred embodiment the distance between two nearest border lines of the holes in the electrically conductive material is between 10 μm and 10 mm.

In another preferred embodiment the electrically conductive material is a noble metal foil perforated with at least one hole.

In another preferred embodiment the side of the membrane being in contact with the electrolyte solution is covered with a stationary phase.

In another preferred embodiment the gas receiving volume is open to the atmosphere.

In another preferred embodiment the gas receiving volume (in this case typically the atmosphere) is separated from the electrically conductive material by a solid plastic body comprising small channels or microcavities or a microporous membrane.

In another embodiment the gas receiving volume is closed, i.e. not open to the atmosphere, comprising a block of porous, preferably hydrophobic, plastic as gas receiving volume which is able to hold the gas emerging from the membrane.

The present invention also provides an electrode connection module for contact with an electrolytic system comprising a field generating membrane electrode according to the invention and a capillary containing elelctrolyte solution, whereby the capillary provides the connection between the electrolytic system and the membrane electrode.

The present invention also relates to the use of a field generating membrane electrode according to the invention for electrokinetic transport, electrokinetic pumping, electrophoretic transport, isotachophoretic transport, separation of ions or electrochemical reaction of ions.

In a preferred embodiment the membrane electrode according to the invention is used in a hydrodynamically controlled system.

In a very preferred embodiment the membrane electrode according to the invention is used in a hydrodynamically controlled system which is a microstructured system with vessels and/or capillaries and/or channels of diameters between 20 μm and 2 mm and capillaries and/or channels with lengths of more than 100 μm.

The present invention further relates to the use of an electrode connection module according to the invention for electrokinetic transport, electrokinetic pumping, electrophoretic transport, isotachophoretic transport, separation of ions or electrochemical reaction of ions.

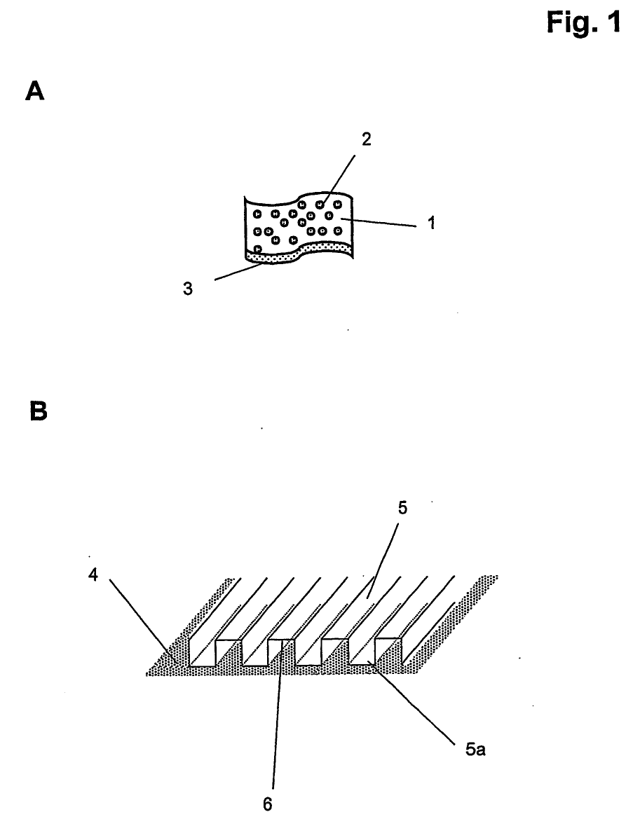

FIG. 1 shows a schematic view of the membrane and the electrically conductive material of the electrode according to the present invention being in direct contact.

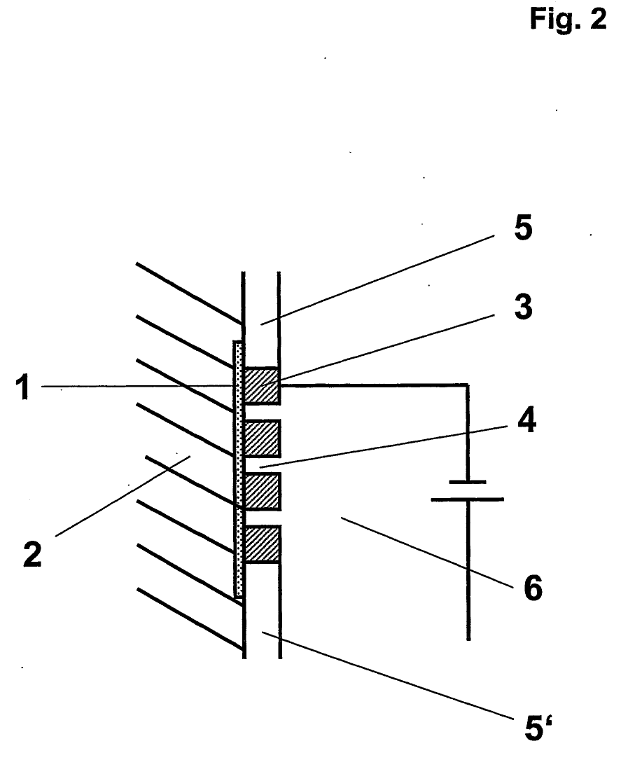

FIG. 2 shows a schematic view of a membrane electrode according to the present invention.

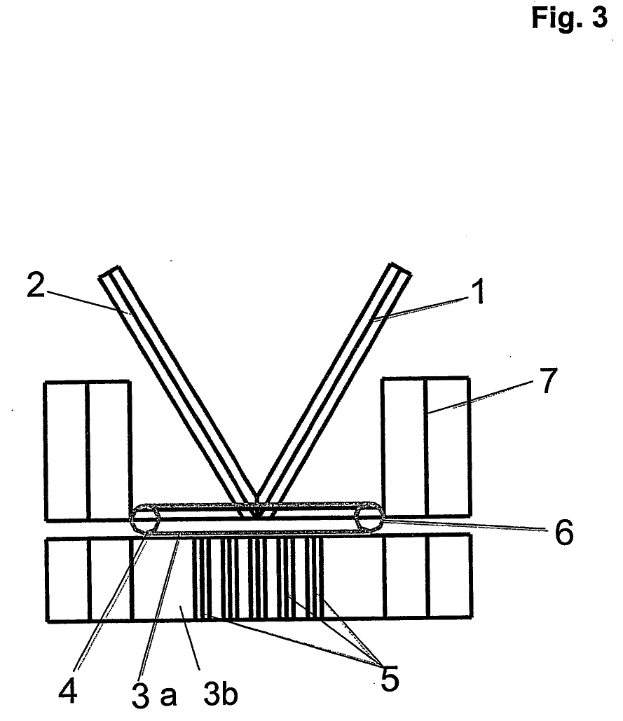

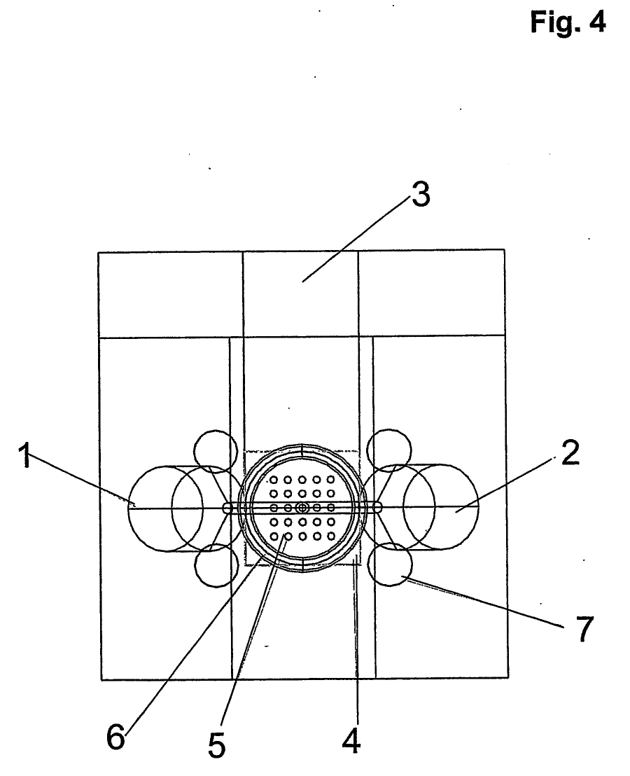

FIGS. 3 and 4 show different schematic views of a preferred embodiment of a solid field generating electrode according to the present invention.

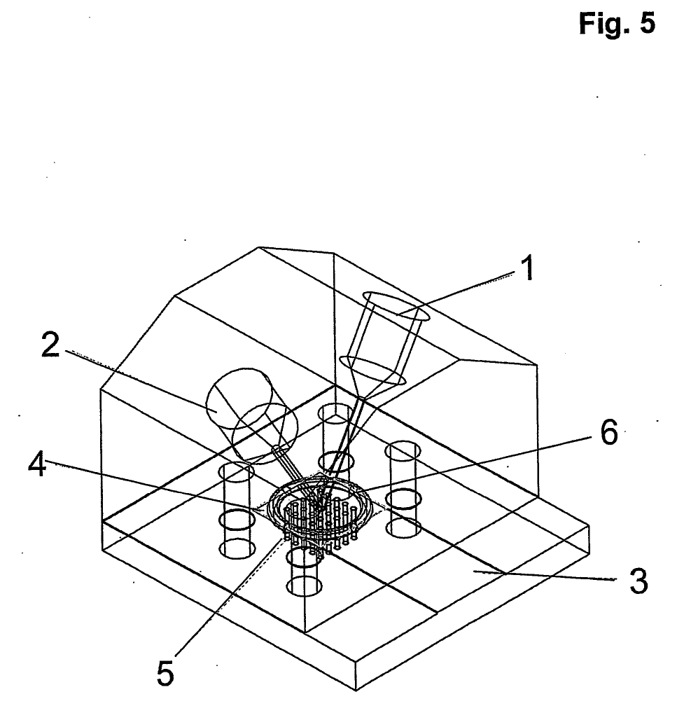

FIG. 5 shows a schematic view of an electrode connection module according to the present invention.

A field generating electrode is any electrode providing an electrical field in order to move molecules or particles like charged particles or ions in electrolyte solutions. The field generating electrode of the present invention is preferably used for applications in which a high voltage between 100 V and 30 kV is needed.

An electrolyte solution is any solution containing polar solvents like e.g. methanol or ethanol or preferably water or mixtures thereof and containing molecules or particles movable in an electric field for example charged particles or ions.

The gist of the present invention is the finding, that it is possible to provide sufficient electrical flow in the electrolyte solution and also to prevent the immersion of gas bubbles into the electrolyte solution when using an electrode comprising an ion permeable membrane in direct contact with a solid conductive material and a gas receiving volume. Whilst one side of the membrane is in a direct contact with the conductive solid and the gas receiving volume, the other side is in direct contact with the electrolyte solution.

The electrode according to the invention at least comprises an ion permeable membrane and a solid electrically conductive material. It typically also comprises fixings, supports or connections by which it is fixed to the apparatus in which it is used.

The transport of ions through the membrane to the conductive material needs to be fast enough to allow a useful electrical current passing the electrode. The kinetics at the conductive surface have to be fast. That means that the built up of a hindering chemical layer has to be prevented. Furthermore, it has to be made sure that the soluble products resulting from reactions at the electrode which are no gases can migrate or diffuse out of the membrane in the electrolyte solution.

At the interface between the membrane and the conductive solid material gases are generated due to electrochemical reactions. Because the available fluid volume for dissolving gas at the interface is extremely small, the emerging gases have an enhanced tendency to build bubbles. Due to the inventive arrangement of the membrane and the conductive solid, the resistance for gas diffusion through the membrane is much greater than the resistance for the transport along the surface and within the conductive solid as gas receiving volume or preferably through holes in the conductive solid material leading to a gas receiving volume. That means, due to the arrangement of the electrode according to the invention, the partial pressure of the emerging gases in the direction of the membrane is higher than the partial pressure in the direction of the conductive material and the gas receiving volume.

The gas receiving volume might be the electrically conductive material itself, a gas absorbing material, any volume filled with gas under normal pressure, under depression or being evacuated, or a direct contact to the outer atmosphere. If the gas receiving volume is the conductive material itself, the material needs to have the ability to take up enough of the emerging gas to avoid the formation of gas bubbles at the interface to the membrane or at least to avoid gas diffusion through the membrane.

In a preferred embodiment the gas receiving volume is made up by holes in the electrically conductive material. The emerging gas is able to leave the interface between the membrane and the electrically conductive material by passing through the holes. On the backside of the conductive solid, there is typically no further hindrance for gas transport. There might e.g. be direct transport through the holes into the atmosphere. The holes may also lead to a gas receiving volume which is filled with gas (e.g. air) under normal pressure or under depression or which is evacuated to enlarge the tendency of the gas emerging from the interface between the membrane and the electrically conductive material to pass through the holes in the gas receiving volume. A hole is any opening, channel or cavity which allows the flow through of gas into the gas receiving volume. In a preferred embodiment the electrically conductive material comprises at least one, preferably a plurality of holes in the form of channels perpendicular to the interface between the membrane and the electrically conductive material leading to the backside of the electrically conductive material. In another embodiment, the channels are at least partly situated in parallel along the interface. These channels may e.g. run to the side end of the interface or one or more of these channels may lead to a perpendicular channel leading to the backside of the electrically conductive material.

In another embodiment, the conductive material is made up of one and more layers of a mesh of very thin metal filaments which allow the passage of gas.

FIG. 1 shows schematic views of different constructions of an ion permeable membrane in direct contact with a solid electrically conductive material according to the present invention bearing holes for contact with a gas receiving volume. The electrolyte solution in contact with the membrane or any fixings etc. are not shown.

In FIG. 1A, the conductive material is a curved foil (1) with holes (2) in it through which gas can move out of the interface between the foil (1) and the membrane (3). The membrane (3) situated under the foil (1) is curved in the same way as the foil (1) and is in direct contact with it.

In FIG. 1B, the conductive material is a foil (5) folded in a way that only parts of the foil (5a) are in direct contact with the membrane (4). The parts of the foil which are not in direct contact with the membrane build a kind of channel structure (6) through which gas can be transported.

The membrane surface area being in contact with the gas receiving volume to some extent allows the evaporation of water from the electrolyte solution
especially if the gas receiving volume is under depression or evacuated, or if there is a direct and intensive contact to the outer atmosphere. The loss of water or the volume flow of water through the membrane might disturb the electrolytical system. This problem is of special importance for microstructured electrophoresis or isotachophoresis systems, especially for hydrodynamically controlled systems. Therefor, it might be favorable to design the electrode according to the present invention in a way that sufficient transport of electrolysis gases is allowed to avoid the formation of gas bubbles and in a way that the evaporation of water is minimized. The latter is achieved by minimizing the direct contact area between the membrane and the gas receiving volume and/or by choosing a gas receiving volume which is not under depression or evacuated. The direct contact area between the membrane and the gas receiving volume is reduced by channels or holes leading from the membrane to the gas receiving volume. To minimize the evaporation of water, it is especially suitable if the holes and/or channels have a very small diameter or if, at least, the side of the holes and/or channels leading into the gas receiving volume has a small diameter. One example for such a design is an electrode according to the invention comprising a membrane being in direct contact with an electrically conductive material which is a solid metal body comprising holes/channels perpendicular to the membrane leading to the back side of the solid metal body. The back side of the solid metal body is covered by a massive plastic body. Contact of the holes/channels of the solid metal body with the outer atmosphere is only provided by channels in the plastic block which have a very small diameter and are preferably not more than scratches or microcavities in the surface of the plastic body being in contact with the metal body. Preferably, the plastic body is made up of a hydrophobic material.

If e.g. a current of 40 uA is applied to a hydrodynamically controlled system comprising electrodes having this design, the contact with the outer atmosphere which is provided by the very small holes and/or channels in the plastic body is sufficient to permit the gas to evaporate from the interface between the membrane and the solid metal body. On the other hand, water evaporation is suppressed to such an extent that a disturbance of the hydrodynamically closed system is not observed.

In another embodiment, the solid plastic body comprising very small channels or microcavities for contact with the gas receiving volume, can be substituted by a microporous membrane separating the solid metal body from the gas receiving volume. The microporous membrane allows the passage of gas but at least makes the evaporation of water more difficult.

Water evaporation can also be reduced by using a gas receiving volume which is closed, i.e. which has no direct contact with the outer atmosphere. This might be achieved by using a porous conductive material with a pore volume which is big enough to hold the volume of gas escaping from the membrane. In another embodiment, a conductive material is used which is not able to hold the gas itself but is in direct contact with another porous material serving as gas receiving volume. This might be e.g. a porous plastic material, preferably a porous hydrophobic plastic material.

The membrane needs to be wetable and permeable for ions, otherwise the membrane can cause problems to the flow of the electric current. Any single membranes or compositions of membranes or nets which have a pore size with a sufficient resistance to gas permeation are suitable membranes for the present invention. Preferably, the membrane has a thickness of 20 to 500 μm, build up by one membrane or membrane layers stably fixed together. In a very preferred embodiment, the membrane is self-sustaining, i.e. a mechanically stable network. The membranes which are preferably used in the present invention are impermeable for particles >50 nm, preferably for particles >10 nm.

The material of the membrane has to be stable in electrolyte solutions and during electrolysis. It typically is an organic polyrner, like cellulose esters, poly(tetrafluorethylene), poly(amides), cross-linked poly(vinylalcohol), cross-linked poly(vinylpyrrolidone).

Suitable membranes are e.g. Spectra/Por membranes for dialysis/ultrafiltration provided by Spectrum® Medical Industries, INC. (Los Angeles, Calif., USA), like Spectra/Por 1 (MWCO 6-8,000), Spectra/Por 2 (MWCO 12-14,000) or Spectra/Por 3 (MWCO 3,500) (MWCO=molecular weight cut off)..

In one embodiment, the side of the membrane being in direct contact with the electrolyte solution is covered with a stationary phase. That means, this side of the membrane is modified by chemically or physically attaching a stationary phase like a gel matrix or a layer of molecules like sugars, proteins, antibodies, nucleic acids, lipids, fatty acids or separation effectors known from affinity chromatography or mixtures thereof for changing or modifying certain properties, especially the binding properties, of the membrane. For example, antibodies can be attached to the membrane so that certain proteins out of a protein mixture which are electrophoretically transported to the membrane will stick to the antibodies. In a next step the polarity of the electrode is switsched whereby only the proteins bound to the antibodies will stick to the membrane. This offers the possibility for fast protein selection. The same principle can also be applied for the selection other molecules, e.g. nucleic acids, certain saccharides etc.:

The specific binding partner of the molecule or group of molecules to be selected is bound to the membrane. The molecule or group of molecules to be selected is, among other molecules, electrophoretically transported to the membrane, and bound thereto via specific binding to the binding partner on the membrane. After changing the polarity of the electrode only the molecules or group of molecules which are specifically bound to the stationary phase of the membrane are retained on the membrane. Specific binding partners for molecules or groups of molecules are known to the person skilled in the art, e.g. from bioseparation methods or affinity chromatography. It is also possible to use generally applicable binding pairs like the avidin/streptavidin—biotin binding pair, if one of the binding partners is attached to the molecules to be selected.

One side of the membrane is in direct contact with the electrolyte solution, the other side is in direct contact with the solid electrically conducting material.

Direct contact means, that at least parts of the side of the membrane are in contact with the medium in question, i.e. the electrolyte solution or the electrically conductive material. To effectively avoid the formation of gas bubbles between the membrane and the conductive material, the distance between them should be smaller than 50 μm, preferably smaller than 10 μm. This is achieved by directly contacting the membrane and the conductive material. Depending on the shape and structure of the membrane and the conductive material it can also be necessary to press them together with the aid of fixings.

Typically, not the whole side of the membrane is in contact with the electrolyte solution or the conductive material respectively, but only a part of the membrane. This is due to constructive requirements as e.g. the edges of the membrane have to be fixed in the electrode assembly. In addition, in the most preferred embodiments of the present invention, only parts of the membrane are in direct contact with the conductive material.

This is due to the fact that the contact of the membrane with the gas receiving volume is preferably achieved via holes in the electrically conductive material. The parts of the membrane facing the holes consequently are in no direct contact with the conductive material.

The electrically conductive solid material is a shaped article, e.g. a foil, body or film, preferably with a flat plain, concave or convex structure. Its size depends on the size of the interface area with the membrane. For microfluidic systems the interface typically has a size between 100 μm² and 3 mm², for other systems its size may be larger.

As described above, the interface between the membrane and the conductive material needs to be build up in a way that gas can move out of it. In a preferred embodiment, this is achieved by using a conductive material with holes for vertical or lateral gas transport in it. Thus, the gas molecules can move along the interface until they reach a hole through which they can leave the interface. Therefore, in a preferred embodiment, the conductive material is a foil, a body or a thin film with holes, a body with internal porous structure or a net structure made of conductive solid or supporting a conductive solid. In a very preferred embodiment, the holes within the electrically conductive material are perpendicular to the membrane, the distance between two nearest border lines of the holes being between 10 μm and 10 mm, preferably between 100 μm and 1 mm.

In another embodiment, sufficient transport of gas molecules away from the interface is achieved by using a conductive material build of a metal or another conductive material with high solvability of gases with or without cavities for gas transport. In this case, the gas molecules can directly permeate the conductive material.

The electrically conductive solid material according to the present invention typically is a metal, a noble metal, an alloy, a conductive carbon (glassy carbon), a conductive polymer, a conductive ceramic or a composit material comprising one or more of the above mentioned materials.

A schematic view of a membrane electrode according to the present invention is given in FIG. 2. The electrode comprises a membrane (1), which is on one side in direct contact with an electrolyte solution (2) and on the other side in direct contact with an electrically conductive material (3) connected with a source of electrical charges. The membrane and the electrically conductive material is fixed to an insulating material (5) representing in this schematic view the connection to the system in which the electrode shall be integrated. The electrically conductive material (3) is perforated with holes (4) providing a direct contact of the membrane (1) with the gas receiving volume (6).

The electrolyte solution being in direct contact with the membrane can also be provided in two or more separated vessels, which are arranged in a way that the electrolyte solutions in the different vessels each contact one part of the membrane.

It is also possible that one electrolyte solution is in contact with two or more membrane electrodes having different electrochemical potentials.

In most cases the reactions at electrode/aqueous fluid interfaces are complex and depend on multiple physical and chemical properties of the electrode and of the solvated molecules. The driving force for electrochemical reactions is formally described for each molecular component i by its electrochemical potential μᵢ′ defined as
μᵢ′=μᵢ+zᵢFΘ
with
μᵢ the chemical potential,
zᵢ the number of electric charges per molecule,
F the Faraday constant and
Θ the inner electrical potential or Galvani potential which is defined as:
Ψ is the outer or Volta potential, the work needed to a charge to the electrode surface within the distance of short reaching interaction ˜10 nm
χ is the work needed to transport a charge through the electrical bilayer to the surface atoms of the electrode,
   while Ψ can be measured in principle, χ cannot be measured.

Furthermore, the ability of the gas which is produced at the interface between the membrane and the conductive material to pass or penetrate the conductive material to reach the backside of the conductive solid where there is no further hindrance for gas transport, is dependent on several factors like:
density of the current on the surface of the conductive solid material
ion concentration in the electrolyte solution and at the membrane/conductive material interface
material and structure of the conductive solid material
material and structure of the membrane
gas back-pressure on the backside of the conductive solid
temperature

An exemplary solution of a preferred electrode according to the present invention is described below:

The conductive solid is a platinum foil of 0.04 mm thickness. In the central part of the foil, about 4 mm in the diameter, 0.5 mm I.D. holes are drilled through with a density of about 25 holes per 16 mm². The backside of the central part of the platinum foil is freely accessible to the atmosphere.

The membrane, placed onto the platinum foil from the side of the electrolyte solution, consists of 3 layers of a porous membrane made of cellulose ester each of about 0.01 mm thickness. The three layers are glued together by an aqueous solution of poly(vinylalcohol).

The membrane is tightly pressed onto the platinum plate by a planar side of the counter-block of the electrode assembly and a silicon rubber O-ring provides a leak tightness to the connection. The accessible free surface of the electrode for the electrolyte solution is about 3 mm². The electrode is integrated into a V-shaped assembly. The branches of the V are filled with the electrolyte solution.

FIGS. 3 and 4 show a schematic view of the electrode described above. FIG. 3 shows a side view of the electrode with a body consisting of a thin film of an electrically conductive material (3a) being in direct contact with the membrane (4) and an insulating body (3b). Both, the electrically conductive material (3a) and the insulating body (3b) bear holes for direct contact of the membrane (4) with a gas receiving volume. The membrane (4) is fixed to the electrically conductive material (3a) with the rubber O-ring (6). The other side of the membrane (4) is in direct contact with the fluidic connections (1) and (2) filled with electrolyte solution. The electrode is fixed into an insulating material (7).

FIG. 4 shows a view from above with the membrane (4) covering the electrically conductive material (3) bearing holes (5) in the area where there is direct contact with the membrane (4). The membrane is fixed to the electrically conductive material (3) with a rubber ring (6). The two fluidic connections (1) and (2) bearing the electrolyte solution are directly facing the other side of the membrane. The electrode arrangement is stabilized in an insulating body with fixings (7).

In the described form the invention was used to perform electrophoretic separations in a miniaturized format using current separation buffers for zone electrophoresis and isotachophoresis separations. The separation times ranged from 2-3 minutes up to 30-40 minutes. Total run times in repeats were tens of hours using the electric currents in the span of 5-20 μA. Using conventional capillary electrophoresis equipment, with about 10 mm² contact area of the working solution to the electrode, tens of runs with the run times up to 40 minutes and with 200-400 μA currents were performed without the occurrence of any gas bubble at the side of the membrane facing the working solution.

The electrode according the invention can be used for any application in which an electrical field is to be generated. According to the invention, systems in which an electrical field is to be generated and in which the electrode according to the invention can be used are called electrolytical systems.

Preferred applications of the electrode according to the present invention are any electrophoretic or electroseparation technique, any electromigration process in which the formation of bubbles may disturb, e.g. electrochromatography, iontophoresis, transdermal application of biological active substances (invasive medical and biological applications affecting the nervous system), electroporation (electrical transport of biological effective substances into cells), electroosmotic pumping (inclusion of the invented electrodes within a closed vessel filled with material which is suitable to generate an electroosmotic flow, any solvent or electrolyte solution which is suitable to be transported by EOF can be displaced), galvanic processes, regeneration of oxidation conditions, prevention of reactive gases Cl₂, O₂ or explosive gases H₂, use in electrochemical synthesis, electrokinetic sampling, electrokinetic sample enrichment, electroblotting on membranes, removal of pathogens from industrial products e.g. DNA from pharma products or the generation of charged gas bubbles.

The electrode according to the present invention is particularly suitable for generating electrical flow in capillary electrophoresis and other microstructured electrophoresis or isotachophoresis systems comprising a capillary and/or microchannel system. In these microstructured electrolytical systems, the formation of gas bubbles in the capillary or channel system would heavily disturb the electrophoretic separation. Microstructured systems particularly are systems comprising vessels and/or capillaries and/or channels with diameters of 2 μm to 2 mm, the capillaries and channels typically having a length of more than 100 μm, preferably between 100 μm and 300 mm.

The membrane electrode according to the present invention is also particularly suitable for use in hydrodynamically controlled, e.g. microstructured systems with closed capillaries or vessels or a closed planar channel structure. Hydrodynamically controlled systems are systems which can be totally closed or isolated from the outside surrounding, that means the internal gas or liquid volume is strictly controlled and can only be exchanged via defined connections like valves or syringes.

Hydrodynamically controlled systems can not be used in combination with electrodes that generate gas bubbles within the system as the hydrodynamical proportions are disturbed by the formation of gas bubbles. The formation of gas bubbles thus hinders the use of electrodes in hydrodynamically controlled microstructured capillary systems. The electrode according to the present invention avoids the formation of gas within the electrolyte solution, i.e. within the system, and is therefor especially suitable for use in hydrodynamically controlled systems. In a very preferred embodiment, the electrode of the present invention is used in hydrodynamically controlled systems in which also the electroosmotic pressure is suppressed.

Electrolytical systems are sometimes also influenced by soluble side products that are generated at the electrodes. Those soluble side products migrate through the membrane into the electrolyte solution and e.g. interact with the analytes. As a consequence, in some cases, it might be advisable to separate the electrolyte solution being in direct contact with the membrane electrode from the working solution. This can be achieved by integrating a second wetable ion permeable membrane which separates the compartment containing the electrolyte solution being in direct contact with the membrane electrode from the vessel or channel system containing the working solution. The compartment thus forms an ion bridge, preventing the immersion of most of the side products into the working solution. The electrolyte solution within the compartment enclosed by the two membranes can be preferably displaced or exchanged separately from the working solution.

To avoid the immersion of soluble side products into the working solution, it is another object of the present invention to provide an electrode connection module. The electrode connection module comprises the inventive electrode and at least one capillary filled with electrolyte solution. The capillary provides contact between the membrane of the electrode and the working solution: One end of the capillary faces the membrane of the electrode, the other end of the capillary is connected with a capillary, vessel or channel of the electrolytical system containing the working solution. As a consequence, the connection of the working solution and the electrode is mediated by a capillary filled with electrolyte solution. The side products generated at the electrode can not directly migrate into the working solution but need to migrate through the capillary. As diffusion through a capillary is a rather slow process, the side products are effectively hindered from migrating into the working solution. Capillaries with a special ratio of length/diameter are especially suitable for delaying diffusion in aqueous solutions. A suitable ratio of length/diameter is 1/10 to 1/40, preferably about 1/20. The capillary typically has a diameter which is smaller than the diameter of the vessel, capillary or channel of the system containing the working solution. In a preferred embodiment, its diameter is about 1/3 to 1/20, preferably about 1/5 to 1/10 of the diameter of the channel or capillary containing the working solution. The capillary might be additionally separated from the capillary or channel containing the working solution by an ion permeable membrane. The electrode connection module according to the present invention is especially suitable for use in microstructured electrolytical systems, especially in microstructured capillary or microchannel systems.

In a preferred embodiment, the membrane of the electrode is not only contacted by the capillary of the electrode connection module but by two capillaries of which one is the capillary of the electrode connection module to contact the electrolytical system and the other is a fluidic connection for filling and emptying the system.

The electrode connecting module can be unexchangeably integrated within an electrolytical system or be a disposable module which can be exchanged independently from the system.

FIG. 5 shows a schematic view of an electrode connection module according to the invention, especially suitable for integration into a microstructured electrolytical system. It comprises the inventive electrode with the conductive solid material (3) with holes (5) in direct contact with the membrane (4). The other side of the membrane is contacted with the capillary which shall hinder diffusion of the side products into the working solution (1) and the fluidic connection capillary (2). The end of the capillaries for contact with the working solution is widened for the insertion of conical fittings for the connection with the capillaries of the electrolytical system. Rubber ring (6) provides a stable fitting of the membrane.

Without further elaboration, it is believed that one skilled in the art can, using the preceding description, utilize the present invention to its fullest extent. The preferred specific embodiments and examples are, therefore, to be construed as merely illustrative, and not limitative to the remainder of the disclosure in any way whatsoever.

The entire disclosures of all applications, patents, and publications cited above and below and of corresponding application EP 01 128031.0, filed Nov. 26, 2001, are hereby incorporated by reference.

1. Field generating membrane electrode for contact with an electrolyte solution comprising a wetable membrane which is ion permeable under electric field conditions and an electrically conductive material for connection with a source of electrical charges, characterized in that one side of the membrane is in direct contact with the electrolyte solution and the other side of the membrane is in direct contact with the electrically conductive material and a gas receiving volume.

2. Field generating membrane electrode according to claim 1, characterized in that the electrically conductive material is a metal foil, body, film or mesh.

3. Field generating membrane electrode according to claim 10, characterized in that the contact of the membrane with the gas receiving volume is achieved by at least one hole in the electrically conductive material.

4. Field generating membrane electrode according to claim 3, characterized in that the distance between two nearest border lines of the holes in the electrically conductive material is between 10 μm and 10 mm.

5. Field generating membrane electrode according to claim 1, characterized in that the electrically conductive material is a noble metal foil perforated with at least one hole.

6. Field generating membrane electrode according to claim 1, characterized in that the side of the membrane being in contact with the electrolyte solution is covered with a stationary phase.

7. Field generating membrane electrode according to claim 1, characterized in that the gas receiving volume is open to the atmosphere.

8. Field generating membrane electrode according to claim 1, characterized in that the gas receiving volume is separated from the electrically conductive material by a solid plastic body comprising small channels or microcavities or a microporous membrane.

9. Electrode connection module for contact with an electrolytical system comprising a field generating membrane electrode according to claim 1 and a capillary containing electrolyte solution which provides the connection between the electrolytical system and the field generating membrane electrode.

10. Use of a field generating membrane electrode according to claim 1 for electrokinetic transport, electrokinetic pumping, electrophoretic transport, isotachophoretic transport, separation of ions or electrochemical reaction of ions.

11. Use of a field generating membrane electrode according to claim 1 in a hydrodynamically controlled system.

12. Use according to claim 11, characterized in that the hydrodynamically controlled system is a microstructured system with vessels and/or capillaries and/or channels of diameters between 2 μm and 2 mm and capillaries and/or channels with lengths of more than 100 μm.
